(19) United States
(12) Patent Application Publication
(10) Pub. No.: US 2014/0151368 A1
(43) Pub. Date: Jun. 5, 2014

(54) INDUCTION HEATING COIL AND PROCESS FOR FUSION WELD JOINING THERMOPLASTIC COMPOSITE PIPE

(71) Applicant: William Adam Morrison, Boaz, AL (US)

(72) Inventor: William Adam Morrison, Boaz, AL (US)

(73) Assignee: AJAX TOCCO MAGNETHERMIC CORPORATION, Warren, OH (US)

(21) Appl. No.: 14/093,718

(22) Filed: Dec. 2, 2013

Related U.S. Application Data
(60) Provisional application No. 61/732,677, filed on Dec. 3, 2012.

(51) Int. Cl. H05B 6/36; H05B 6/10

(52) U.S. Cl. CPC H05B 6/36; H05B 6/101
USPC 219/674; 219/676

(57) ABSTRACT

A method and apparatus are provided for pipe joint fusion-welding and other applications, in which a hinged clamshell inductor apparatus is wound from a single contiguous length of Litz wire cable with turns of each half of the clamshell apparatus configured so that their individual magnetic fields are additive to induce uniform longitudinal current flow providing uniform circumferential heating in a carbon steel susceptor tube inserted within pipe ends to be joined.

### REFERENCE TO RELATED APPLICATION

This application claims priority to, and the benefit of, U.S. Provisional Patent Application Ser. No. 61/732,677, filed on Dec. 3, 2012, entitled INDUCTION HEATING COIL AND PROCESS FOR FUSION WELD JOINING THERMOPLASTIC COMPOSITE PIPE, the entirety of which application is hereby incorporated by reference.

### FIELD OF DISCLOSURE

The present disclosure relates generally to fusion welding and more particularly to methods and apparatus for joining thermoplastic composite pipe sections.

### BACKGROUND

Heating of thermoplastic composite pipes is sometimes used for joining pipe ends for repair or other field installation uses. Conventional approaches for such thermoplastic composite pipe heating include resistively heating wire embedded in the joint, as well as pressing together pipes heated in a hotbox for joint fusion during cool-down. Clamping type inductors have been designed in the past, primarily of water-cooled copper tubing. Typical clamping inductors are made from rigid water cooled copper conductors, and require a mechanical hinge point to join the two halves of the inductor. This mechanical hinge must carry electrical currents that range from a few hundred to several thousand amps and has thus proven to be a weak point of the rigid water-cooled conductor approach to building and clamshell/clamping style inductor. Potential failure modes include overheating due to a variety of reasons, such as the operator forgetting to tighten the mechanical hinge after installation. Overheating can occur due to insufficient surface area in the hinge contact area and/or mechanical wear resulting in reduced contact area.

### SUMMARY

One or more aspects of the disclosure are now summarized to facilitate a basic understanding of the disclosure, wherein this summary is not an extensive overview of the disclosure, and is intended neither to identify certain elements of the disclosure, nor to delineate the scope thereof. The primary purpose of the summary, rather, is to present some concepts of the disclosure in a simplified form prior to the more detailed description that is presented hereinafter. The present disclosure relates to a method and apparatus for pipe joint fusion-welding and other applications in which a hinged clamshell inductor apparatus is wound from one or more contiguous lengths of Litz wire cable with turns of each clamshell half oriented such that the corresponding magnetic fields are additive and induce uniform longitudinal current flow providing uniform circumferential heating in a carbon steel susceptor tube or other interior magnetic load.

### BRIEF DESCRIPTION OF THE DRAWINGS

The following description and drawings set forth certain illustrative implementations of the disclosure in detail, which are indicative of several exemplary ways in which the principles of the disclosure may be carried out. The illustrated examples, however, are not exhaustive of the many possible embodiments of the disclosure. Other objects, advantages and novel features of the disclosure will be appreciated from the following detailed description of the disclosure when considered in conjunction with the drawings, in which:

FIG. 1 is a simplified diagram illustrating a clamshell induction heating apparatus with longitudinally disposed induction coil windings radially outward of a pair of pipe ends to be joined with a sacrificial steel susceptor tube section situated near the joint for providing heating through induced current flow;

FIG. 2 is a flow diagram illustrating an exemplary induction heating method;

FIG. 3 is a front perspective view of a clamshell induction heating apparatus embodiment with a handle and closable latches for joining thermoplastic composite pipe sections in accordance with one or more aspects of the present disclosure;

FIG. 4 is a rear perspective view of the apparatus of FIG. 5 showing hinges and Litz wire connections;

FIG. 5 is an and perspective view of the clamshell induction heating apparatus shown in the closed position;

FIG. 6 is an and perspective view of the clamshell induction heating apparatus in an opened position;

FIG. 7 is an and elevation view showing the clamshell induction heating apparatus in a closed position with pipe sections installed in the interior for heating;

FIG. 8 is a top plan view of the clamshell induction heating apparatus showing internal Litz coil windings thereof;

FIG. 9 is a rear elevation view of the clamshell induction heating apparatus showing portions of internal Litz coil windings of the upper and lower halves;

FIG. 10 is a front elevation view of the clamshell induction heating apparatus showing further portions of the Litz coil windings; and

FIG. 11 is a partial schematic diagram illustrating the configuration of the Litz coil windings in the upper and lower clamshell halves of the induction heating apparatus connected to a power supply.

### DETAILED DESCRIPTION

Referring now to the figures, several embodiments or implementations of the present disclosure are hereinafter described in conjunction with the drawings, wherein like reference numerals are used to refer to like elements throughout.

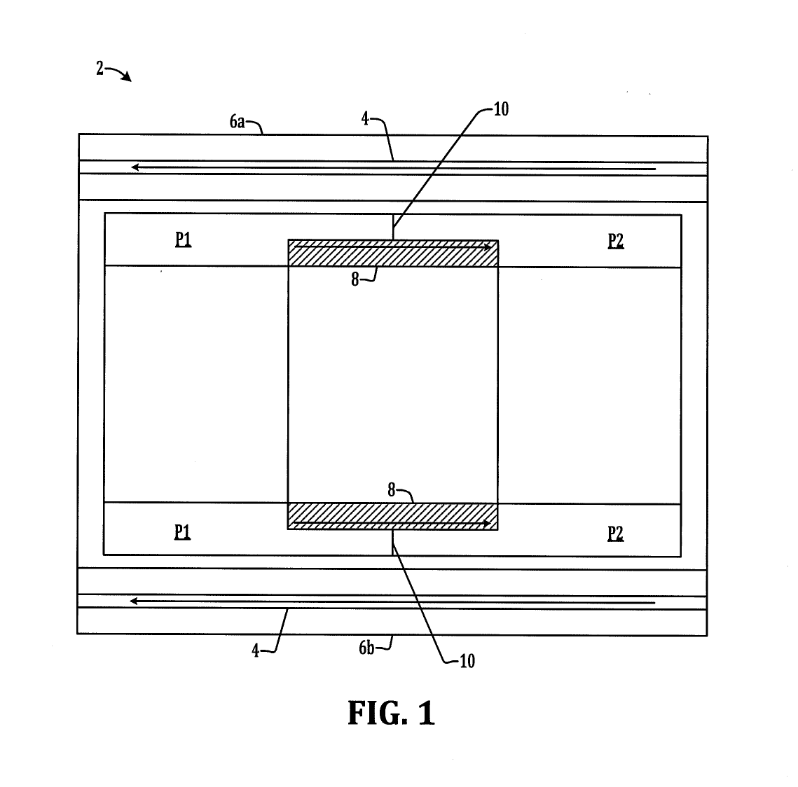

FIG. 1 illustrates an apparatus 2 for induction heating which can be employed in a variety of applications. As illustrated, the apparatus 2 is used for joining the ends of first and second pipes P1 and P2 by induction fusion welding using a carbon steel or other suitable magnetic susceptor tube 8, where the pipes in this application are polyethylene or other thermoplastic compound materials, and the ends thereof are joined at a joint 10. The apparatus 2 includes an enclosure 6 having an upper or top half 6a and a lower or bottom half 6b on or in which one or more Litz wires 4 are disposed in a generally longitudinal fashion in a central portion so as to provide a transverse magnetic field for inducing generally longitudinal (axial) induced current within the susceptor tube 8. Any suitable form or type of Litz wire can be used, including without limitation multiple strands insulated electrically from one another, where the strands may be twisted or woven according to any suitable pattern. Moreover, the Litz wire 4 may be constructed using several levels or groups of twisted wires being twisted together, so as to ideally equalize the proportion of the overall length over which each strand is at the outside of the Litz wire conductor 4. As seen in FIG. 1, current flowing to the left within the upper and lower Litz wires 4 induces longitudinal current flow in the opposite direction within the susceptor 8 (e.g., left to right in the figure). The apparatus 2 in certain embodiments includes a lightweight housing 6, such as a two-part epoxy resin designed to maintain spacing between Litz coil turns and the relative geometry thereof, in addition to providing mechanical mounting for laches, closures, carrying handles, hinges, etc.

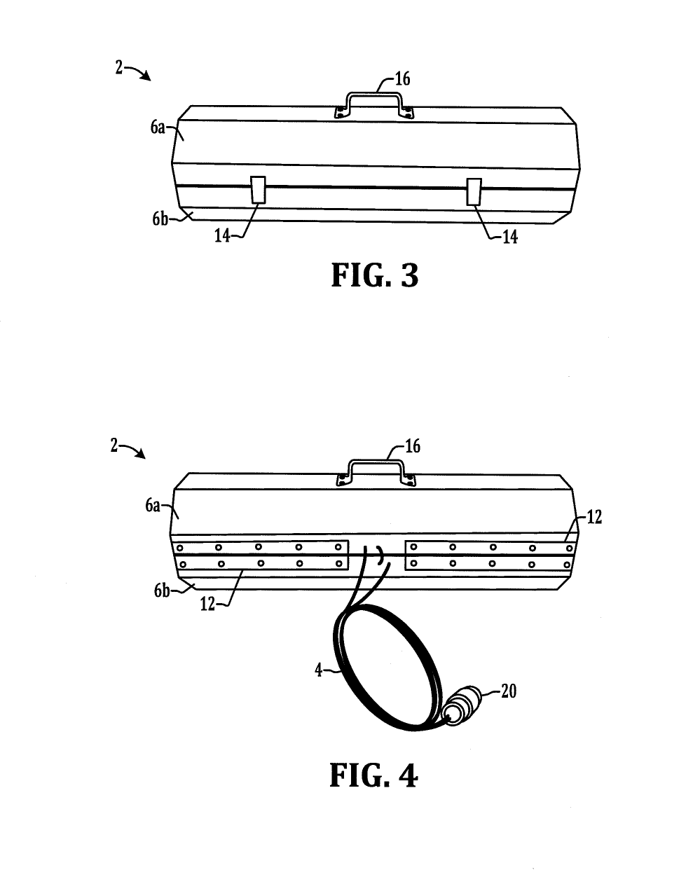

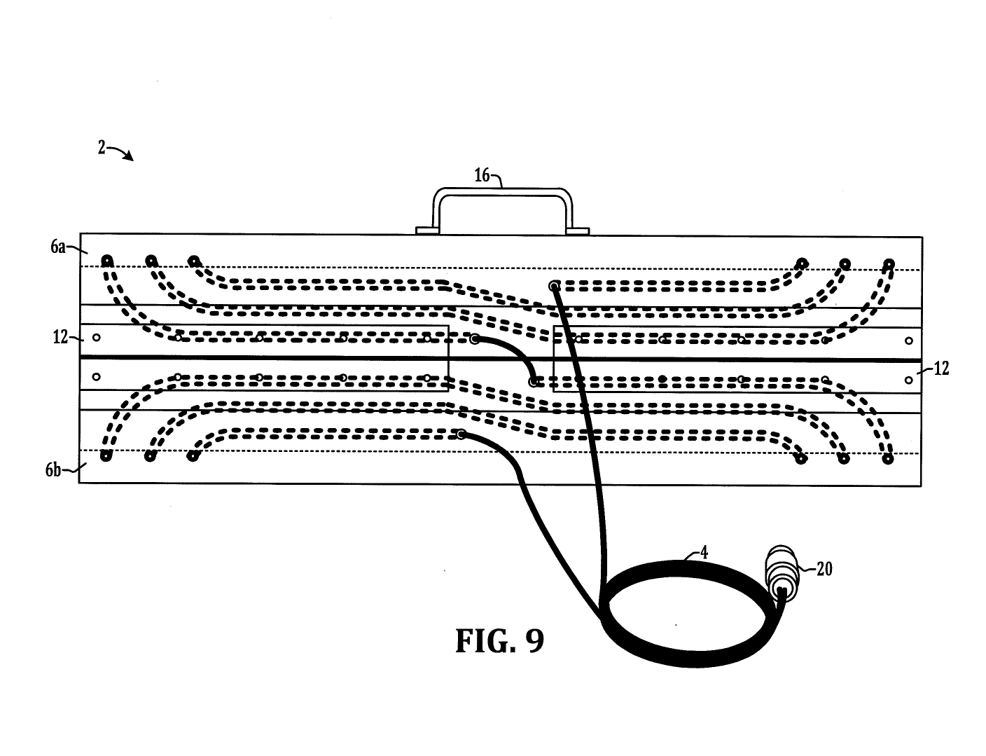

The apparatus 2 is further illustrated in FIGS. 3-11, and may be used as a fusion Weld inductor in certain applications. In the illustrated usage, the apparatus 2 is configured for use as a fusion Weld inductor, and in this case is a 100% air cooled, clamshell type induction heating coil designed to provide full circumferential uniform heating to a metal tube (sacrificial carbon steel susceptor tube 8 in FIG. 1) primarily for the purpose of welding/joining thermoplastic (polyethylene) composite pipes P1, P2. However, the apparatus 2 can also be used for other applications such as thawing frozen liquids inside of metallic pipe, curing protective coatings on/in pipe, preheating pipe prior to welding applications, stress relieving pipe welds and warming liquids within drums buckets or other containers.

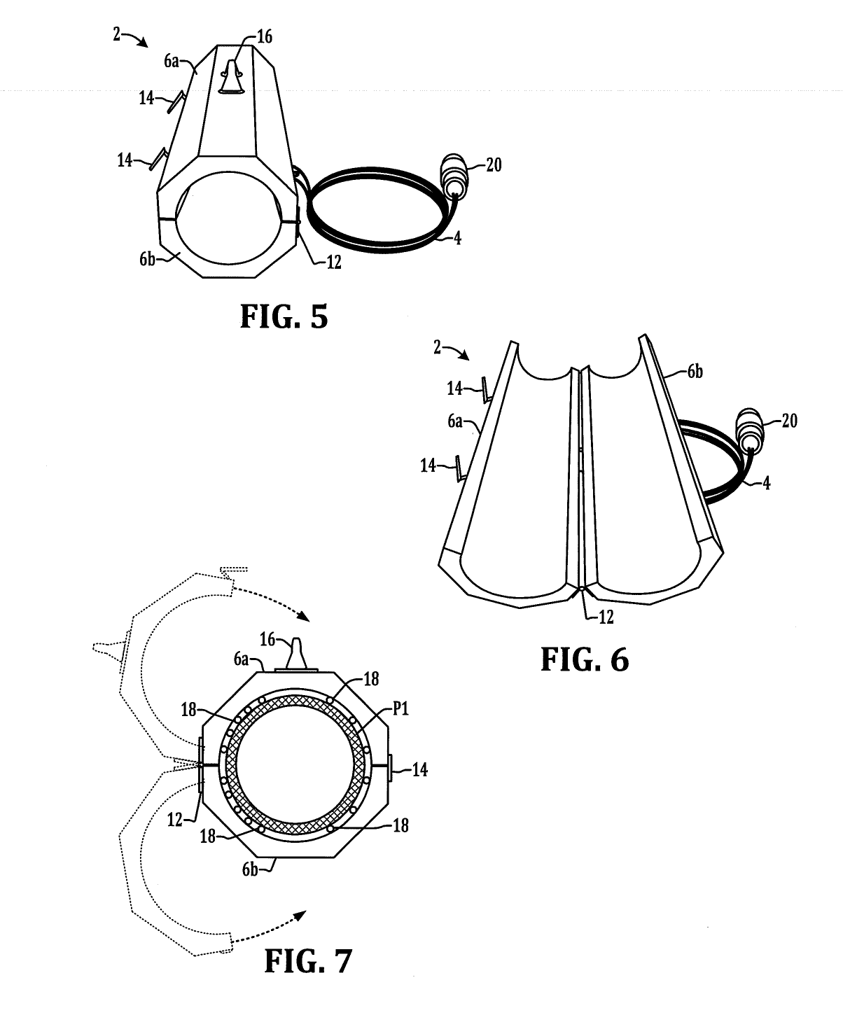

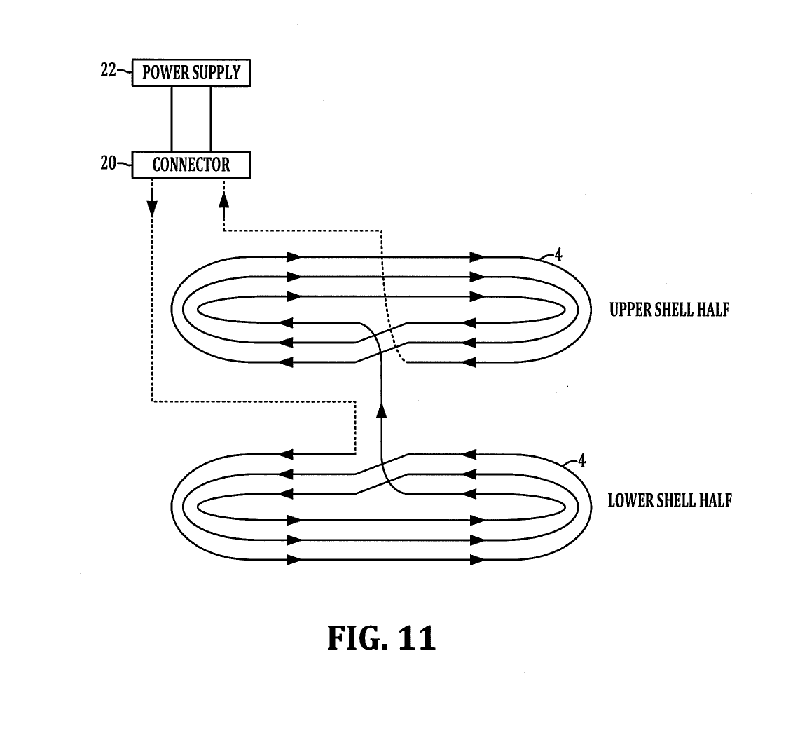

As seen in FIGS. 3 and 4, the inductor apparatus 2 includes latches 14 on the front side for securing the upper and lower halves 6a and 6b in a closed position as well as hinge assemblies 12 mounted to the back sides of the upper and lower halves 6a and 6b. In addition, handle 16 is provided on the top half 6a for easy transportation of the apparatus 2. As further shown in FIG. 4, moreover, the Litz coils 4 extend outward from the assembly 2 terminating in a connector 20 for connection to a power supply 22 (FIG. 11). As further detail below, the illustrated embodiment includes a generally continuous Litz coil 4 extending from one connection at the connector 20 into the upper inductor half 6a, with a crossover connection from the upper half 6a to the lower half 6b, and returning out of the lower half 6b to another connection point of the connector 20. Although the illustrated embodiment includes a single Litz coil 4 routed through both the upper and lower halves 6a and 6b, separate Litz coils 4 can be provided within each of the halves 6, and may be terminated in connectors (not shown) allowing external connections to be made for connection to the power supply 22 as well as to connect the windings of the upper and lower halves 6 together. FIG. 5 illustrates a perspective and view of the apparatus 2, which in one implementation has an octagonal outer profile, with a cylindrical interior profile to accommodate one or more heated workpieces, such as to pipes P1, P2 to be joined along with a sacrificial susceptor 8 (FIG. 1). FIG. 6 illustrates an and view of the apparatus 2 in an opened position, and FIG. 7 illustrates an end elevation view showing the apparatus 2 closed around a pipe workpiece P1 along with aluminum rods or other spacers 18 providing a controlled spacing between the cylindrical inner wall of the enclosure halves 6a and 6b and the outer diameter of the workpiece P1. Other embodiments are possible in which spacers 18 are formed as part of the enclosure 6, such as bumps, ribs, or other structures extending inwardly from the cylindrical inner surface of the enclosure halves 6a and/or 6b to control the spacing of a heated workpiece relative to the inner wall of the enclosure 6. In addition, although illustrated as having a cylindrical inner surface, the inner surface of the enclosure halves 6a and/or 6b can be of different forms, shapes, etc., and the two portions 6a and 6b may, but need not be bilaterally symmetrical. In this regard, while each of the illustrated halves 6a and 6b generally extend around approximately half of the workpiece profile (e.g., 180°), other embodiments are possible in which one or more of the component portions 6a and/or 6b extend around an angle less than 180°, and more than two parts may be provided to constitute the enclosure 6 in certain implementations.

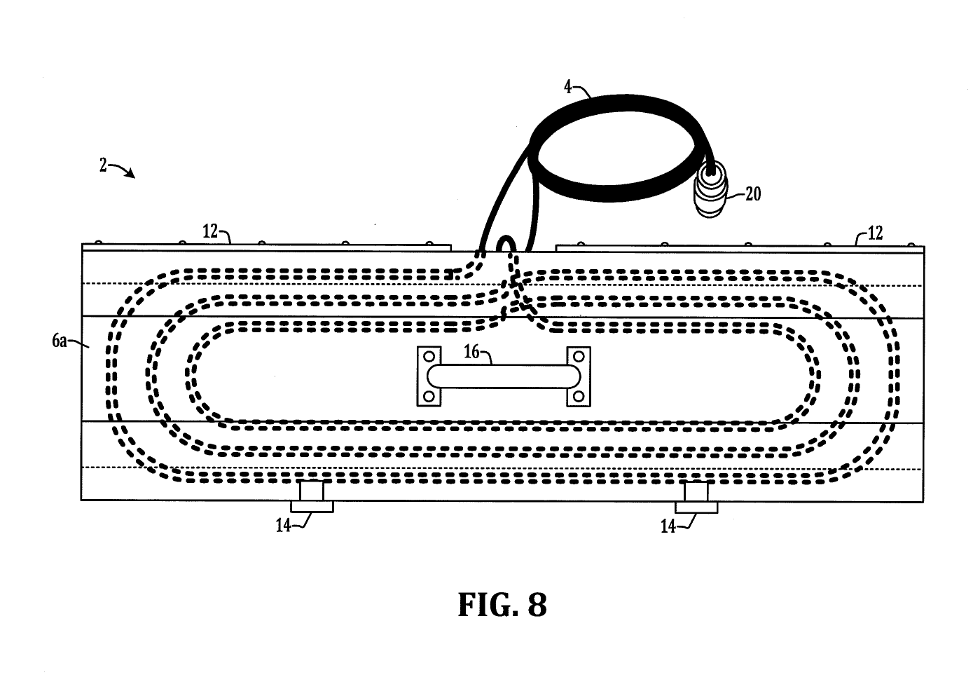

As seen in FIGS. 8-10, the Litz coil 4 in this embodiment is embedded within the walls of the enclosure halves 6a and 6b, and portions thereof may be exposed through parts of the inner surface of the enclosure pieces 6 and/or the outer surfaces of the pieces 6. As seen in FIG. 8, the Litz coil 4 forms a series of three loops in the upper half 6a, with an outer loop starting from an external portion of the Litz coil 4 at the back of the apparatus 2 and looping around to a first crossover approximately at the center of the back, subsequently forming a middle loop and a second crossover to form an inner loop. At approximately the center of the back portion of the apparatus 2, the inner loop continues outside the upper half 6a and enters the lower half 6b, where the winding of the Litz coil 4 in the lower half 6b forms a similar three-loop configuration (not shown in the figure). FIG.

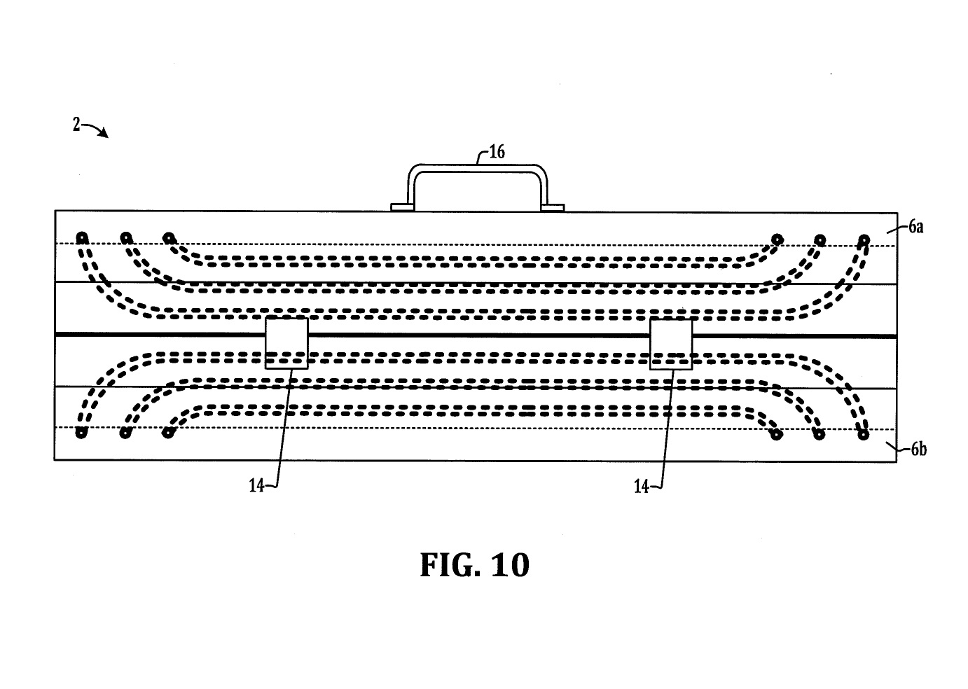

9 illustrates the back side of the apparatus 2, again showing the interior Litz coil winding pattern 4 in dashed lines, including the above-described winding configuration of the upper half 6a, and a similar winding configuration with two crossovers in the lower half 6b. FIG. 10 illustrates a plan view of the front side of the induction heating apparatus 2, in which the returns of the respective loops in the upper and lower halves 6a and 6b do not include crossovers.

FIG. 11 schematically illustrates the winding path of the upper and lower halves 6 with the halves 60 and, whereby the Litz coil 4 forms a single coil configuration extending through the loop patterns of the upper and lower halves 6 in the illustrated embodiment. Other implementations are possible in which more or fewer than three loops are provided for a given Litz coil 4 in either or both of the upper and lower enclosure halves 6a, 6b, and multiple Litz coils 4 can be employed in other embodiments, with external connection thereof in parallel to the power supply 22 and/or in series with one another, and/or any suitable series/parallel interconnection configurations.

As further shown in FIG. 11, the inductor apparatus 2 in certain embodiments is powered by a 5 kW air cooled solid state induction heating power supply/inverter, such as a 5/20 kW TOCCOtron type AC power supply 22 (FIG. 11) manufactured and sold by Ajax TOCCO Magnethermic Corporation, but the apparatus 2 can be modified to be powered by a wide arrange of commercially available induction heating power supplies. The inductor apparatus 2, moreover, advantageously provides a clamshell design which allows the inductor to open up like a clamshell e.g., FIGS. 6 and 7 above) to be placed around a metal or plastic pipe without having to “thread” the pipe inside the diameter of the inductor. This is advantageous if the heated area of the pipe is located a relative long distance from the end of the pipe, the ends of the pipe are obstructed, or the pipe is physically too heavy to be moved safely to the heating inductor.

Moreover, unlike conventional clamshell inductor coils, the illustrated apparatus 2 is made using air-cooled Litz wire 4, and thus has no coolant fluid requirements which makes the apparatus 2 ideally suited to field use. In this regard, the lack of water requirements and the flexible nature of the Litz wire 4 offers several distinct advantages over traditional rigid water-cooled copper conductors. Typical clamping inductors made from rigid water-cooled copper conductors require a mechanical hinge point to join the two halves of the inductor. This mechanical hinge must carry electrical currents that range from a few hundred to several thousand amps and has thus proven to be a weak point of the rigid water-cooled conductor approach to building a clamshell/clamping style inductor. Potential failure modes of conventional techniques include overheating due to a variety of reasons, such as the operator forgetting to tighten the mechanical hinge after installation. Overheating can occur due to insufficient surface area in the hinge contact area and/or mechanical wear resulting in reduced contact area.

The flexible air-cooled Litz wire 4 of the disclosed apparatus 2 advantageously permits both halves of the clamshell inductor in certain embodiments to be wound from a single contiguous length of cable 4, thus eliminating the mechanical hinge that would normally be required with rigid water-cooled clamshell type inductors. The elimination of the hinge eliminates the requirement to verify tightness and cleanliness of the hinge prior to operation. It also eliminates issues associated with insufficient contact surface area within the hinge. By eliminating the requirement for a mechanical hinge in the current-conducting path, the apparatus 2 also greatly reduces the physical size, complexity and production costs of the typical clamshell type inductor, making it more practical for use in remote service environments such as Arctic oil fields, offshore drilling platforms, etc.

In addition, while conventional induction heating coils use water for maintaining a safe operating temperature, the illustrated apparatus 2 instead uses air-cooled Litz wire 4 as a conductor and is much more efficient at carrying high frequency currents than a typical thin walled copper tube. The air-cooled nature of the apparatus 2 offers a technical advantage in that it reduces the amount of equipment that has to be installed to perform the induction heating application. The need for a water-cooling and recirculation system is eliminated, reducing overall system costs, installation labor, transportation, etc. Furthermore, issues associated with the disposal of used cooling liquid are also eliminated by the disclosed apparatus 2. In particular, the cooling liquid may contain significant concentrations of anti-freeze chemicals (glycol) to prevent the coolant from freezing in cold operating environments. The cooling liquid can also pick up traces of heavy metals such as copper, lead, zinc, etc. during use, further highlighting the issues of coolant disposal and the advantages of the air-cooled technology offered by the apparatus 2.

The illustrated embodiment 2 provides a pair of pancake style inductors wound in a series configuration, each on an associated half 6a, 6b of the clamshell structure 6. One pancake inductor is used on each side of the clamshell in the illustrated embodiment, with each being curved to conform to the radius of the pipe 8/P1/P2 being heated (e.g. FIGS. 1 and 7). The longitudinal (e.g., axial) length of the pancake inductor in certain embodiments is determined by the required length of heated area on the pipe P1/P2. The turns spacing and geometry of the pancake inductors are positioned to provide the best possible uniformity over the full length of the heated area and the full circumference of the pipe diameter.

The pancake style inductors provide transverse magnetic flux that can normally heat only one side of a flat sheet metallic object. However due to the unique winding orientation (e.g., FIGS. 8-11) and interconnection of each pancake inductor, the transverse field from each pancake inductor is able to induce uniform longitudinal current flow that uniformly heats the circumference of a metallic tube susceptor 8 (FIG. 1), and thus uniform heating of the pipe P1, P2 portions being joined. Thus, the apparatus 2 can create uniform circumferential heating using longitudinal current flow from a transverse flux magnetic field. The turns of each half of the portions 6a and 6b are configured so that their individual magnetic fields add to each other and do not cancel out due to opposing fields. The inductor windings or Litz coils 4 are disposed in the illustrated embodiment in a two-part epoxy resin enclosure structure 6, which may be used in conjunction with spacing rods 18 (FIG. 7) or other spacers which may be integral to the enclosure 6, and order to maintain turns spacing and geometry as well providing mechanical points to secure mechanical closures/latches, carrying handles and piano hinges. Part locators, proximity switches and temperature measuring devices can also be secured to the inductor assembly via metallic threaded inserts embedded into the resin material in certain implementations.

The encapsulation/resin material can be changed/modified to accommodate varying environmental conditions to be more compatible with cold or hot environments, corrosive environments, clean room environments, etc. The installation and use of the apparatus 2 is very simple, and typically requires no tools. The apparatus 2 in the illustrated embodiments is equipped with a tool-less inductor connector that allows it to be plugged directly into the back of the induction heating power supply 22 and secured by turning a threaded collar. The operator simply unlocks the plastic closures 14 on the front side of the apparatus 2, opens the inductor clamshell structure halves 6a and 6b, and places it around the pipe to be heated, followed by closing the plastic latches 14. Once installed, the operator then can command the induction heater power supply 22 to apply heat based on a predetermined recipe or temperature feedback device. Furthermore, the apparatus 2 maybe include one or more integral thermocouples (not shown) disposed at suitable locations such as within the interior of the enclosure halves 6 in order to provide feedback signals to a closed loop induction heating control system for improved control over the temperature of a heated article within the interior of the enclosure 6.

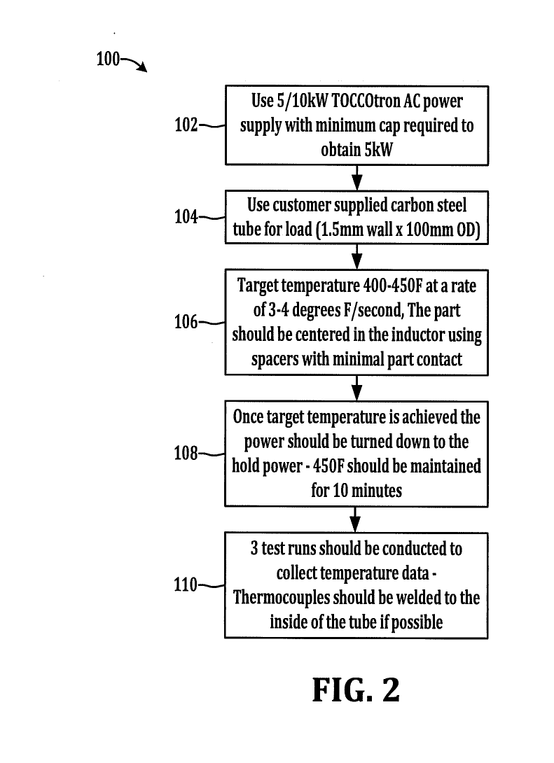

FIG. 2 illustrates an exemplary process or method 100, including connection of a power supply 22 (e.g., using a given minimum capacitance to obtain about 5 kW AC output power in one example) at 102, and the use at 104 of a steel tube or other susceptor (e.g., susceptor tube 8 in FIG. 1 above) as an induction heating load. The process is used at 106 to join two lengths of the thermoplastic composite pipe P1, P2 shown in FIGS. 1 and 7, primarily by using induction heating to heat the embedded susceptor (carbon steel tube) 8 located within the ID of the two pipes P1, P2 being joined as shown in FIG. 1 above. At 108 in FIG. 2, the power is decreased to a “hold” power level (e.g., 450° F. in one example) once the target temperature is achieved, and the whole temperature is maintained for about 10 minutes in one possible example using a 5 inch diameter pipe within a six-inch cylindrical inner cavity provided by the shell halves 6. As seen at 110 in FIG. 2, moreover, certain embodiments employ three test runs to collect temperature data, wherein the apparatus 2 may include various thermocouples and/or such may be installed on the sacrificial carbon steel susceptor tube 8 or combinations thereof. The susceptor 8 in the example of FIG. 1 is centered within the joint area 10. The OD of the joint area 10 in certain embodiments may be covered with a sleeve/coupling made from a thermoplastic composite (polyethylene). The apparatus 2 is placed over the OD of the thermoplastic coupling. When energized, the apparatus 2 creates a magnetic field that induces an electrical current within the embedded susceptor 8 located on the ID of the pipes P1/P2 being joined. The induced current causes the susceptor 8 to generate internal heat, which radiates through the layers of the pipe P1/P2 and coupling causing the composite layers to be fused together creating a hermetically sealed pipe joint.

One major advantage for this joining technology is related to cycle time and the cost of down time related to the value of gas and or oil or other material flowing through the pipe. Use of the illustrated apparatus 2 can create a joint between a pair of pipes in as little as 15 minutes. Competing joining technologies require up to an hour to create a safe joint, whereby the illustrated apparatus 2 can provide significant cost savings, particularly considering the value of the product flowing through the pipe. Existing “butt fusion” and “socket fusion” technologies basically use a hot iron and/or oven to elevate the temperature of the plastic pipe to a molten temperature at which point the two pipes are pressed together until they cool, creating a bond. Significant time to heat the welding iron and or the pipe is required, as well as the ability to longitudinally translate one or both of the pipe sections during the process. Further traditional plastic joining processes are hard to document and verify due to the level of operator involvement and the number of variables, thus raising concerns about the quality, repeatability and safety of the joint integrity.

The illustrated technology addresses documentation, safety and quality issues by being able to close the loop with the process control. With the illustrated apparatus 2, the heating and bonding process are combined into a single step. With induction heating, moreover, it is possible to measure the exact coil voltage, current, their phase relation, and exact energy input to the inductor 2 in order to document the performance of the induction heating process for each joint created. An exactly repeatable preprogrammed recipe for each joint size can then be used each time a joint is created. Since the susceptor, pipe and coupling tolerances can be closely controlled and are installed prior to heating, many variables are eliminated. It is further possible to input temperature feedback devices (e.g., thermocouples) into the joint area to document the temperature profile and other critical characteristics of the joining process. All this data can be input into a master controller to accurately control and document the entire process. Additional data can be collected such as geostationary location of where the joint was created through the use of a GPS receiver. The date, time and name of the operator can also be input and collected providing the greatest possible level of documentation for critical joints such as these that are found within the oil and gas industry.

The above examples are merely illustrative of several possible embodiments of various aspects of the present disclosure, wherein equivalent alterations and/or modifications will occur to others skilled in the art upon reading and understanding this specification and the annexed drawings. In particular regard to the various functions performed by the above described components (assemblies, devices, systems, and the like), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the illustrated implementations of the disclosure. In addition, although a particular feature of the disclosure may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”.

Having thus described the invention, the following is claimed:

1. An induction heating apparatus, comprising:
a clamshell housing with first and second parts, the housing defining an interior space to accommodate a workpiece along an axis;
first and second Litz wire coils individually disposed on or in one of the first and second parts of the clamshell housing, and connected in series with one another, the individual Litz wire coils extending generally parallel to the axis along at least a middle portion of the housing; and
a connector apparatus for coupling the first and second Litz wire coils to a power source.

2. The induction heating apparatus of claim 1, wherein the first and second parts of the clamshell housing are fabricated of plastic.

3. The induction heating apparatus of claim 1, wherein the Litz wire coils are disposed within the first and second parts of the clamshell housing.

4. The induction heating apparatus of claim 1, wherein the Litz wire coils form multiple loops within each of the first and second parts of the clamshell housing.

5. The induction heating apparatus of claim 4, wherein the loop formations in each of the first and second parts of the clamshell housing include crossovers.

6. The induction heating apparatus of claim 1, wherein the first and second parts of the clamshell housing individually extend around approximately 180° of a heated workpiece in an interior defined by the clamshell housing parts in a closed position.

7. The induction heating apparatus of claim 1, wherein the first and second parts of the clamshell housing defining a generally cylindrical interior of the induction heating apparatus in a closed position.

8. The induction heating apparatus of claim 1, wherein the first and second parts of the clamshell housing are connected to one another using at least one hinge assembly.

9. The induction heating apparatus of claim 8, comprising at least one latch to hold the first and second parts of the clamshell housing in a closed position.

10. The induction heating apparatus of claim 9, wherein the first and second parts of the clamshell housing are fabricated of plastic.

11. The induction heating apparatus of claim 10, wherein the Litz wire coils are disposed within the first and second parts of the clamshell housing.

12. The induction heating apparatus of claim 11, wherein the Litz wire coils form multiple loops within each of the first and second parts of the clamshell housing.

13. The induction heating apparatus of claim 12, wherein the loop formations in each of the first and second parts of the clamshell housing include crossovers.

14. The induction heating apparatus of claim 10, wherein the Litz wire coils form multiple loops within each of the first and second parts of the clamshell housing.

15. The induction heating apparatus of claim 14, wherein the loop formations in each of the first and second parts of the clamshell housing include crossovers.

16. The induction heating apparatus of claim 1, comprising at least one latch to hold the first and second parts of the clamshell housing in a closed position.
